(19) United States
(12) Patent Application Publication
(10) Pub. No.: US 2007/0169307 A1
(43) Pub. Date: Jul. 26, 2007

(54) Adjustable castor assembly

(75) Inventors: Jun Yu, Brampton (CA); Vicente P. Nunes, Streetsville (CA); Bruce Gordon Hollett, East Garafraxa (CA)

Correspondence Address: PILLSBURY WINTHROP SHAW PITTMAN, LLP, P.O. BOX 10500, MCLEAN, VA, 22102, US

(73) Assignee: Xerox Corporation, Stamford, CT (US)

(21) Appl. No.: 11/339,536

(22) Filed: Jan. 26, 2006

(51) Int. Cl. B60B 33/00

(52) U.S. Cl. 16/30

(57) ABSTRACT

The disclosure provides an adjustable castor wheel assembly for attachment to an object and a system for supporting an object comprising a plurality of wheel assemblies. The adjustable castor wheel assembly comprises a mount constructed to be attached to the object, and a stud extending from the mount in an axial direction. The assembly also comprises an adjusting member rotatably engaged with the stud so that a rotation of the adjusting member in a first direction causes a distance between the mount and the adjusting member in the axial direction to increase while a rotation of the adjusting member in a second direction causes the distance between the mount and the adjusting member in the axial direction to decrease. The assembly also comprises a castor wheel rotatably attached to the adjusting member.

### FIELD

The present disclosure relates to adjustable wheel assemblies and, more particularly, to adjustable castor wheel assemblies that can readily be adjusted manually.

### BACKGROUND

Previous adjustable castor wheel assemblies typically included a stem facilitating adjustment that protruded above a mount, thus interfering with the supported object, such as a large machine or cabinet. Adjustable feet that do not interfere with the object do not provide adequate mobility. Thus, there is a need for an adjustable castor wheel assembly for supporting objects such as machines, cabinets, desks, chairs, etc., that is compact and provides high mobility.

### SUMMARY

One aspect of the disclosure provides an adjustable castor wheel assembly for attachment to an object. The assembly comprises a mount constructed to be attached to the object, and a stud extending from the mount in an axial direction. The assembly also comprises an adjusting member rotatably engaged with the stud so that a rotation of the adjusting member in a first direction causes a distance between the mount and the adjusting member in the axial direction to increase while a rotation of the adjusting member in a second direction causes the distance between the mount and the adjusting member in the axial direction to decrease. The assembly also comprises a rolling member rotatably mounted to the adjusting member, the rolling member being rotatable to rollingly support the object.

Another aspect of the disclosure provides a system for supporting an object. The system comprises a plurality of wheel assemblies disposed between the object and a supporting surface. At least one of the wheel assemblies is an adjustable castor wheel assembly comprising a mount constructed to be attached to the object, and a stud extending from the mount in an axial direction. The at least one adjustable castor wheel assembly also comprises an adjusting member rotatably engaged with the stud so that a rotation of the adjusting member in a first direction causes a distance between the mount and the adjusting member in the axial direction to increase while a rotation of the adjusting member in a second direction causes the distance between the mount and the adjusting member in the axial direction to decrease. The adjustable castor wheel assembly also comprises a rolling member rotatably mounted to the adjusting member, the rolling member being rotatable to rollingly support the object.

Other objects, aspects, and advantages of the disclosure will become apparent from the following detailed description, the accompanying drawings, and the appended claims.

### BRIEF DESCRIPTION OF THE DRAWINGS:

The above-mentioned and other features and advantages of this disclosure, and the manner of attaining them, will become more apparent and the disclosure itself will be better understood by reference to the following description taken in conjunction with the accompanying drawings, wherein:

FIG. 1 is an exploded view of an adjustable castor wheel assembly in accordance with the disclosure;

FIG. 2 is a side-view of the adjustable wheel assembly depicted in FIG. 1 when the assembly is in its most compact configuration;

FIG. 3 is a side-view of the adjustable wheel assembly depicted in FIG. 1 when the assembly is in an extended configuration; and

FIG. 4 is a cross-sectional view of the adjustable wheel assembly depicted in FIGS. 1-3 taken along the line A-A′ in FIG. 3.

The embodiment will be described with reference to the accompanying drawings. Corresponding reference characters indicate corresponding parts throughout the several views. The description as set out herein illustrates an arrangement of an embodiment and is not to be construed as limiting the scope of the disclosure in any manner.

### DETAILED DESCRIPTION

The Figures show a compact adjustable castor wheel assembly 10 that is readily adjustable by a user and is of sound construction so that it is capable of providing support and mobility for heavy objects. Further, the configuration utilizes a compact design so that there is no interference between parts of the wheel assembly and parts of the object to be supported.

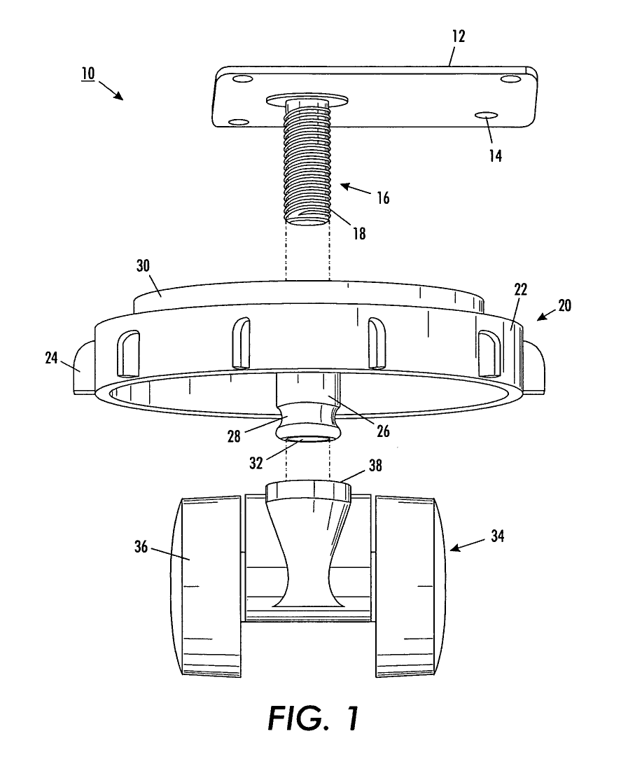

FIG. 1 shows how the parts of a compact adjustable castor wheel assembly 10 interrelate. In overview, a mount 12 is secured to an object to be supported (not shown), and includes a stud 16 extending therefrom. The stud 16 has external threads 18. A wheel assembly 34 attaches to an adjusting member 20. The adjusting member 20 includes a hollow bore 32 that has internal threads that may engage the external threads 18 on the stud 16 extending from the mount 12. As will become clear in the following discussion, a rotation of the adjusting member 20 acts to change the distance that the stud 16 extends into the hollow bore 32 and, accordingly, acts to change the overall height of the compact adjustable castor wheel assembly 10 and therefore the height of the supported object.

With reference to FIG. 1, a mount 12 may be fastened to any object desired to be supported by means of holes 14 and any suitable fastening means (not shown) such as, e.g., screws, bolts, rivets, nails, etc. The mount 12 is here depicted as a rectangular plate but one of skill in art would recognize that other shapes could also function as an attaching means such as, e.g., a circular, triangular, or irregularly shaped mount, without limitation. Moreover, other structures besides a plate may be used, and the mount may be any suitable structure that attaches the assembly to an object. The mount 12 includes a stud 16 extending therefrom in an axial direction. The stud 16 may be attached to the mount 12 by any suitable means, and preferably there is no relative movement in the axial direction between the stud 16 and the mount 12. The stud 16 may be fastened to the mount 12 as described or may alternatively be formed as an integral and uniform part with the mount. In either case, the stud 16 is formed with external threads 18.

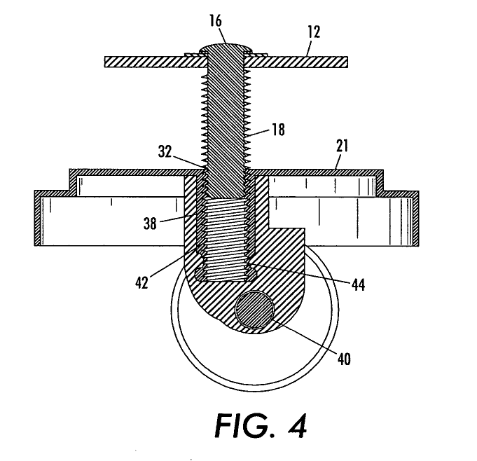

With continuing reference to FIG. 1 and additionally with reference to FIG. 4, the compact adjustable castor wheel assembly further includes an adjusting member 20 and a wheel assembly 34. The wheel assembly 34 is fitted onto an attachment member 26 depending from the adjusting member 20. The attachment member 26 may be secured to the adjusting member 20 by any suitable fastening means or may be formed integrally with the adjusting member 20 so as to create one solid, uniform, member. The attachment between the wheel assembly 34 and the adjusting member 20 may be of a snap-in type in which a raised annular protrusion 44 within a bore 38 in the wheel assembly 34 fits into an annular channel 28 disposed about a bottom portion of the attachment member 26. In this case, the attachment member 26 is inserted into the bore 38 of the wheel assembly 34 and, upon application of sufficient pressure, the end part of the attachment member 26 is pushed past the annular protrusion 44 and snaps into place, permitting free rotation of the wheel assembly 34 about the axis defined by the bore 38 and the attachment member 26. While a snap-in type attachment is depicted in the drawings and described herein, it is appreciated that the scope of the disclosure is not limited to that particular arrangement and that any suitable attachment mechanism may be used to secure the wheel assembly 34 onto the adjusting member 20.

For purposes of the present disclosure, the term “castor wheel” is understood to encompass the broad class of typically small wheels generally used to support objects and to provide ease of mobility. A brake or lock mechanism is sometimes activated in order to prevent a castor wheel from rolling. Castor wheels typically swivel about an axis perpendicular to a supporting surface to allow for easy change of direction, but the term is also meant to include wheels that may selectively swivel by activation or deactivation of a brake or lock mechanism.

The adjusting member 20 and wheel assembly 34 will now be described in greater detail, with continuing reference to FIGS. 1 and 4. After the wheel assembly 34 is attached to the adjusting member 20 as described above, the adjusting member and wheel assembly combination may be connected to the mount 12 and stud 16 assembly in accordance with the description below. Alternatively, the adjusting member 20 may be connected to the stud 16 prior to attachment of the wheel assembly 34; the particular order of attachment will depend upon the specific hardware used and efficiency of effort, the scope of the disclosure not being limited to any particular order of attachment.

The wheel assembly 34 may be a castor wheel comprising one or more wheels 36 mounted to rotate about one or more axles 40. The number of wheels and axles necessary in any particular application is determined by the parameters of the arrangement, including weight, mobility, structural, and material considerations, as one of skill in the art would recognize. The wheel assembly includes a bore 38 for attachment to the adjusting member 20, as described above. The wheel assembly 34 may alternatively be any suitable rolling member and may be rotatably mounted to the adjusting member to rollingly support the object.

The adjusting member 20 is generally cylindrical and has a top planar surface 21 substantially closing the top side, and the bottom side may be open. The top surface 21, by itself or in combination with a manually engageable portion 22, may alternatively be either arcuate or slightly rounded, thereby taking on a generally hemispherical shape. The manually engageable portion 22 of the adjusting member may be sized so as to provide a sufficient gripping surface for the hand of a user to hold and rotate. While the size of the manually engageable portion 22 is described as being sufficiently large to be gripped by a user's hand, it is nonetheless appreciated that space limitations may dictate that the size of the manually engageable portion be kept relatively small such that it would preclude the possibility for adjustment by hand. As such, the present embodiment also contemplates the portion 22 being sized to allow for quick adjustment with the aid of a tool.

The adjusting member 20 further includes a hollow bore 32 in its substantial center that is coaxial and coextensive with the attachment member 26. The coextensive nature of the hollow bore 32 and the attachment member 26 contributes to the compactness of the adjustable wheel assembly 10, thereby requiring very little operating space and reducing interference with other objects and other parts of the supported object. The hollow bore 32 includes internal threads 42 that are dimensioned to engage with the external threads 18 of the stud 16. FIG. 3 shows a side view of the compact adjustable wheel assembly when the three main parts, the wheel assembly 34, the adjusting member 20, and the mount/stud combination (12, 16), are all attached as described above.

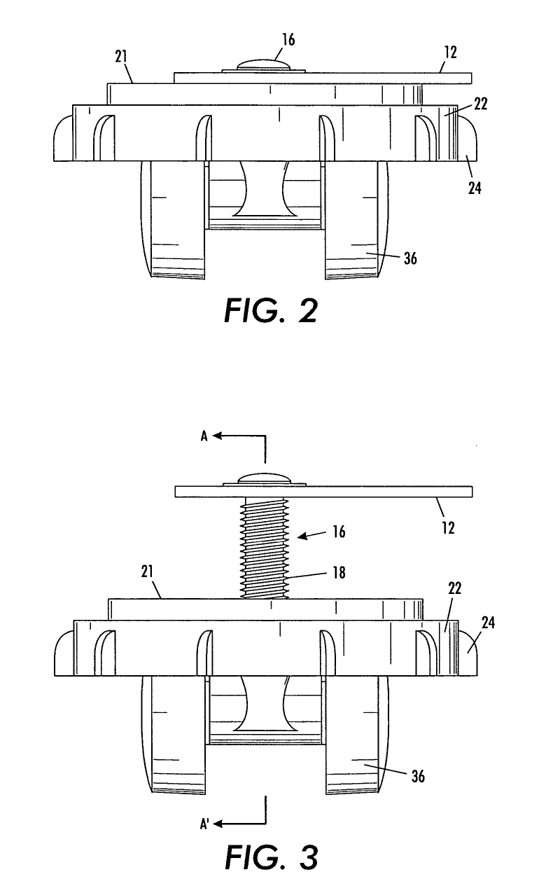

The configuration shown in FIG. 3 also represents the maximum, or close to the maximum, height of the compact adjustable wheel assembly in providing support for an object. When the bottom of the stud 16 is screwed into the hollow bore 32 just far enough so as to establish a sturdy fit, the stud 16 extends outwardly from the bore 32 and establishes the maximum amount of additional clearance afforded. If the supported object is desired to be lower, a user may grip the adjusting member 20 and continue to rotate it in a first direction further along the stud 16. This will drive the stud 16 further into the hollow bore 32 and act to lower the mount 12 and the supported object accordingly. FIG. 2 shows the configuration of the assembly in its most compact position. As can be seen therein, the adjusting member 20 has been rotated fully in the first direction and the stud 16 has been fully driven into the hollow bore 32 such that the mount 12 abuts the top surface 21 of the adjusting member 20.

A rotation of the adjusting member 20 in a second, opposite, direction will naturally cause the stud 16 to be driven further out of the hollow bore 32 and to raise the height of the supported object. Thus, the height of a supported object can quickly and easily be adjusted in either direction by rotating the adjusting member 20 in one or the other direction. The adjusting member 20 is large enough and shaped accordingly so that it can be gripped by the hand of user, thus obviating the need for a tool or other device to effect the height adjustment.

As shown in FIGS. 1-3, the adjusting member 20 may include protrusions 24 to further enhance the ability of a user to grip the member 20. The protrusions 24 are here shown as ten in number (four being hidden) and are equally spaced about the outer periphery of the adjusting member 20. It is understood, however, that the number of protrusions 24 can be changed in order to suit the particular needs of the application of the device. As such, the protrusions can be of any quantity (i.e., as low as one and as high as whatever amount will fit along the periphery of the adjusting member 20) that provides some measure of additional gripping ability to the user. Alternatively, the protrusions 24 can instead be formed as depressions in the surface of the adjusting member 20 and may be take on any shape that will enhance the ability to grip.

A system of compact adjustable wheel assemblies may be used to support a single object. In doing so, the object may be leveled or tilted to precise specifications by individually adjusting each of the adjustable wheel assemblies. It is also recognized that the adjustable wheel assemblies can be used in combination with non-adjustable wheels or feet to support a single object without losing the ability to level the object. That is, if an object is supported by two adjustable wheels and two non-adjustable wheels, it is still capable of being precisely leveled by virtue of the adjustability of just the two adjustable wheel assemblies. Further, if an object is supported by two adjustable wheel assemblies on one side of the bottom surface and two feet on the other, the object may still be leveled and may also be moved by lifting the side with the feet and rolling the object on the wheels. Any number of adjustable wheel assemblies may be used alone or in conjunction with other supporting mechanisms to support an object. For example, a small object may need as little as three wheels while an extremely large and/or heavy object may require as many as ten or more wheels. The particular application of the compact adjustable wheel assembly will apprise one of skill in the art as to a suitable quantity and distribution of the wheels.

Representative examples of objects that may be supported by an adjustable castor wheel assembly (or a plurality of the same) include: photocopiers, printers, work tables, chairs, rolling work stations, carriages or shopping carts, any form of furniture, table saws, fax machines, displays, etc. Any object for which rolling support is desired may incorporate one or more of these adjustable castor wheel assemblies.

While specific embodiments have been described above, it will be appreciated that the subject of the present disclosure may be practiced otherwise than as described. The descriptions above are intended to be illustrative, not limiting. Thus, it will be apparent to one skilled in the art that modifications may be made without departing from the scope of the claims set out below.

What is claimed is:

1. An adjustable wheel assembly for attachment to an object comprising:
a mount constructed to be attached to the object;
a stud extending from the mount in an axial direction;
an adjusting member rotatably engaged with the stud so that a rotation of the adjusting member in a first direction causes a distance between the mount and the adjusting member in the axial direction to increase while a rotation of the adjusting member in a second direction causes the distance between the mount and the adjusting member in the axial direction to decrease; and
a rolling member rotatably mounted to the adjusting member, the rolling member being rotatable to rollingly support the object.

2. The assembly according to claim 1, wherein the rolling member is part of a castor wheel assembly pivotally attached to the adjusting member for adjusting an orientation of the rolling member.

3. The assembly according to claim 1, wherein the rolling member is a wheel.

4. The assembly according to claim 1, wherein:
the stud has external threads; and
the adjusting member includes a hollow bore with internal threads to rotatably engage the external threads of the stud.

5. The assembly according to claim 1, wherein the adjusting member includes a center portion that rotatably engages the stud, and a manually engageable portion extending radially outwardly therefrom.

6. The assembly according to claim 5, wherein the manually engageable portion of the adjusting member is generally circular.

7. The assembly according to claim 6, wherein the manually engageable portion of the adjusting member is generally hemispherical.

8. The assembly according to claim 7, wherein the manually engageable portion of the adjusting member includes raised protrusions to allow for gripping.

9. The assembly according to claim 8, wherein the raised protrusions are disposed about a periphery of the manually engageable portion of the adjusting member.

10. A system for supporting an object comprising:
a plurality of wheel assemblies disposed between the object and a supporting surface;
wherein at least one of the wheel assemblies is an adjustable wheel assembly comprising:
a mount constructed to be attached to the object;
a stud extending from the mount in an axial direction;
an adjusting member rotatably engaged with the stud so that a rotation of the adjusting member in a first direction causes the distance between the mount and the adjusting member in the axial direction to increase while a rotation of the adjusting member in a second direction causes the distance between the mount and the adjusting member in the axial direction to decrease; and
a rolling member rotatably mounted to the adjusting member, the rolling member being rotatable to rollingly support the object.

11. The system according to claim 10, wherein the rolling member is part of a castor wheel assembly pivotally attached to the adjusting member for adjusting an orientation of the rolling member.

12. The system according to claim 11, wherein the rolling member is a wheel.

13. The system according to claim 10, wherein:
the stud has external threads; and
the adjusting member includes a hollow bore with internal threads to rotatably engage the external threads of the stud.

14. The system according to claim 10, wherein the adjusting member includes a center portion that rotatably engages the stud, and a manually engageable portion extending radially outwardly therefrom.

15. The system according to claim 14, wherein the manually engageable portion of the adjusting member is generally circular.

16. The system according to claim 15, wherein the manually engageable portion of the adjusting member is generally hemispherical.

17. The system according to claim 16, wherein the manually engageable portion of the adjusting member includes raised protrusions to allow for gripping.

18. The system according to claim 17, wherein the raised protrusions are disposed about a periphery of the manually engageable portion of the adjusting member.

19. The system according to claim 10, wherein each of the plurality of wheel assemblies is an adjustable castor wheel assembly comprising:
a mount constructed to be attached to the object;
a stud extending from the mount in an axial direction;
an adjusting member rotatably engaged with the stud so that a rotation of the adjusting member in a first direction causes the distance between the mount and the adjusting member in the axial direction to increase while a rotation of the adjusting member in a second direction causes the distance between the mount and the adjusting member in the axial direction to decrease; and
a rolling member rotatably mounted to the adjusting member, the rolling member being rotatable to rollingly support the object.
